(19) United States
(12) Patent Application Publication
(10) Pub. No.: US 2014/0009420 A1
(43) Pub. Date: Jan. 9, 2014

(54) INFORMATION TERMINAL DEVICE, METHOD TO PROTECT HANDWRITTEN INFORMATION, AND DOCUMENT MANAGEMENT SYSTEM

(71) Applicants: Mayuka ARAUMI, Ohta-ku (JP); Ikue Kawashima, Yokohama-shi (JP)

(72) Inventors: Mayuka ARAUMI, Ohta-ku (JP); Ikue Kawashima, Yokohama-shi (JP)

(21) Appl. No.: 13/936,411

(22) Filed: Jul. 8, 2013

(30) Foreign Application Priority Data
Jul. 9, 2012 (JP) 2012-153227
Jun. 26, 2013 (JP) 2013-134064

(51) Int. Cl. G06F 3/0354

(52) U.S. Cl. CPC G06F 3/03545
USPC 345/173

(57) ABSTRACT

In order to prevent confidential information inputted in handwriting from being divulged, an information terminal device has an input section to input information in handwriting on an entry screen which displays a designated form of a document, a judgment section judging whether or not an inputted positional coordinate is in a particular field of the designated form, and a control section controlling the entire information terminal device to display the information inputted in handwriting within the particular field in the particular field while the coordinate of the information inputted in handwriting is within the particular field, and to make the information inputted in handwriting displayed in the particular field unreadable when the coordinate of the information inputted in handwriting is outside of the particular field or when a predetermined time frame has elapsed since the last stroke in the particular field.

### CROSS-REFERENCE TO RELATED APPLICATIONS

The present application is based on and claims priority from Japanese Patent Application Number 2012-153227, filed on Jul. 9, 2012, and Japanese Patent Application Number 2013-134064, filed on Jun. 26, 2013, the disclosure of which is hereby incorporated by reference herein in its entirety.

### BACKGROUND OF THE INVENTION

1. Field of the Invention

The present invention relates to an information terminal device, a method to protect handwritten information, and a document management system.

2. Description of the Related Art

Previously, when confidential information such as personal information or a passcode written on a paper document was handled, the confidential information used to be hidden by a sticker to prevent a third party from seeing.

Furthermore, a variety of measures to protect confidential information used to be taken also in the field of electronic information. For example, when a passcode is inputted on an information-processing device, inputted information including letters and numbers is displayed for every digit and converted into an asterisk (*) when the next digit is displayed. As an example of the information-processing device having such a structure, Japanese published unexamined application 2004-341590 (Patent Document 1) has been proposed. Moreover, as an alternative measure, when the passcode is inputted on a personal computer (PC) by use of a keyboard, the inputted passcode is displayed as an asterisk (*) from the beginning.

### SUMMARY OF THE INVENTION

In addition to the above, some types of information terminal devices are configured such that information is inputted in handwriting by use of a stylus pen or its equivalent. When confidential information about things such as credit card or passcode is inputted in handwriting on such information terminal devices, the inputted information remains displayed even after sending it to a server. Thus, there is a risk of a third party seeing the information before the display is switched to another screen. Further, there is a security problem in that a third party who has access authority over information in the server can access the inputted information even after it has been sent to server.

In view of the foregoing problems, the present invention aims to provide an information terminal device preventing confidential information inputted in handwriting from being divulged, a method of protecting the handwritten information, and a document management system.

The present invention is mainly characterized by having an input section to input information in handwriting on an entry screen displaying a designated form of a document, a judgment section judging whether or not a positional coordinate inputted in handwriting is within a particular field of the designated form, and a control section controlling the entire information terminal device to display the information inputted in handwriting within the particular field on the particular field while the coordinate of the information inputted in handwriting remains within the particular field, and to make the information inputted in handwriting displayed in the particular field unreadable when the coordinate of the information inputted in handwriting is outside of the particular field or when a predetermined time frame has elapsed since the last stroke in the particular field.

According to the present invention, confidential information inputted in handwriting can be prevented from being divulged.

### BRIEF DESCRIPTION OF THE DRAWINGS

FIG. 1 illustrates a configuration of an information terminal device according to the present invention;

FIG. 2 illustrates an input processing according to the present invention;

FIG. 3 is a flowchart of an input processing according to the present invention;

FIG. 4 is a flowchart of confidential information processing according to the present invention;

FIG. 5A illustrates a configuration of a document management system according to the present invention;

FIG. 5B illustrates a configuration of a document management system according to the present invention;

FIG. 6 is a displayed content on a PC when a user or third party accesses a server from the PC.

### DETAILED DESCRIPTION OF THE PREFERRED EMBODIMENTS

An embodiment of the present invention will be described hereinafter with reference to the accompanying drawings. In the present invention, confidential information about things like a credit card or passcode inputted in handwriting by use of a stylus pen or its equivalent is converted into unreadable information soon after inputting or before sending to a server. Therefore, confidential information can be prevented from being seen by a third party.

Moreover, confidential information can be prevented from being divulged by access of a third party to a server through a PC even after a user has sent handwritten information to the server, since the confidential information about things like a credit card or passcode has been converted into unreadable information if the third party browses that on a PC.

### (First Embodiment)

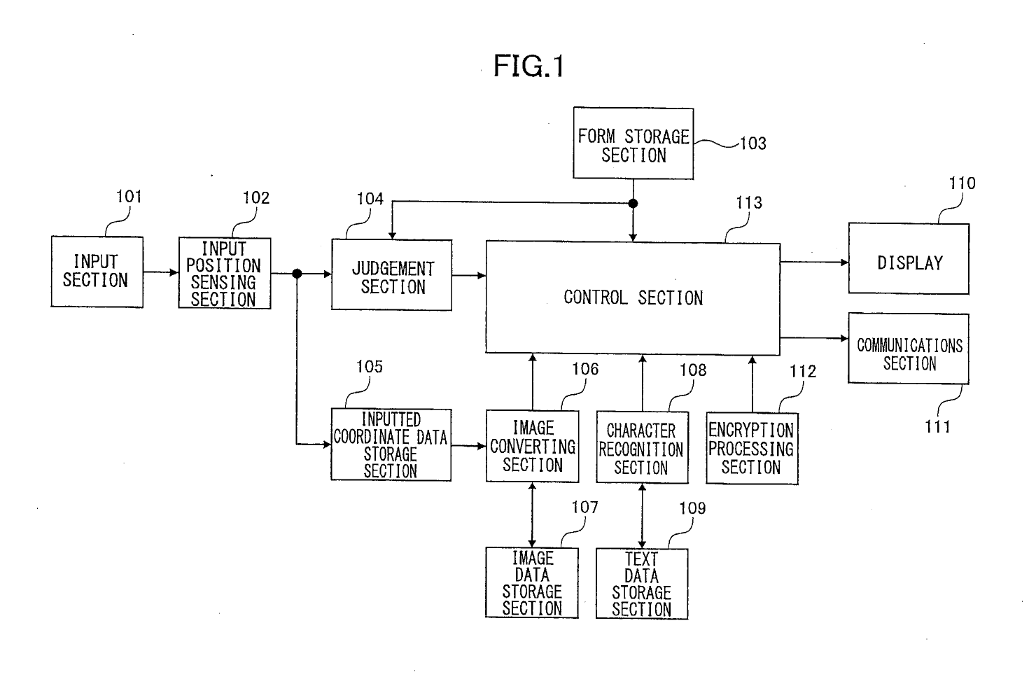

FIG. 1 illustrates a configuration of the information terminal device according to the present invention, wherein 101 indicates an input section which is a touch panel to input information in handwriting by a touch operation with a fingertip or a stylus pen, 102 indicates an input position sensing section which senses inputted positional coordinates, 103 indicates a form storage section which stores various designated forms such as an application form, a checklist, an inventory sheet, and a questionnaire, 104 indicates a judgment section which judges whether or not a positional coordinate inputted by touch operation is within a particular field of the form, 105 indicates a coordinate data storage section which stores the inputted positional coordinate inputted by touch operation, 106 indicates an image converting section which converts the inputted positional coordinate data into an image data, 107 indicates an image data storage section which stores the image data, 108 indicates a character recognition section which recognizes a handwritten character and converts it into a text data, 109 indicates a text data storage section which stores the text data recognized in the character recognition section, 110 indicates a display of the touch panel which displays images such as the document form and the handwritten information inputted, 111 indicates a communicating section which sends and receives data to and from a server, 112 indicates an encryption processing section which encrypts the text data by use of an encryption key, and 113 indicates a control section which controls the entire information terminal device.

For an input type of the input section 101 according to the present invention, any touch panel including a resistive touch panel, a capacitive touch panel, or an electromagnetic induction touch panel may be used. The touch panel is integrally formed of the input section 101 and the display 110. A document image of the designated form read out from the form storage section 103 is displayed on an input field, and the touch panel comes to a state such that handwriting can be inputted by a user.

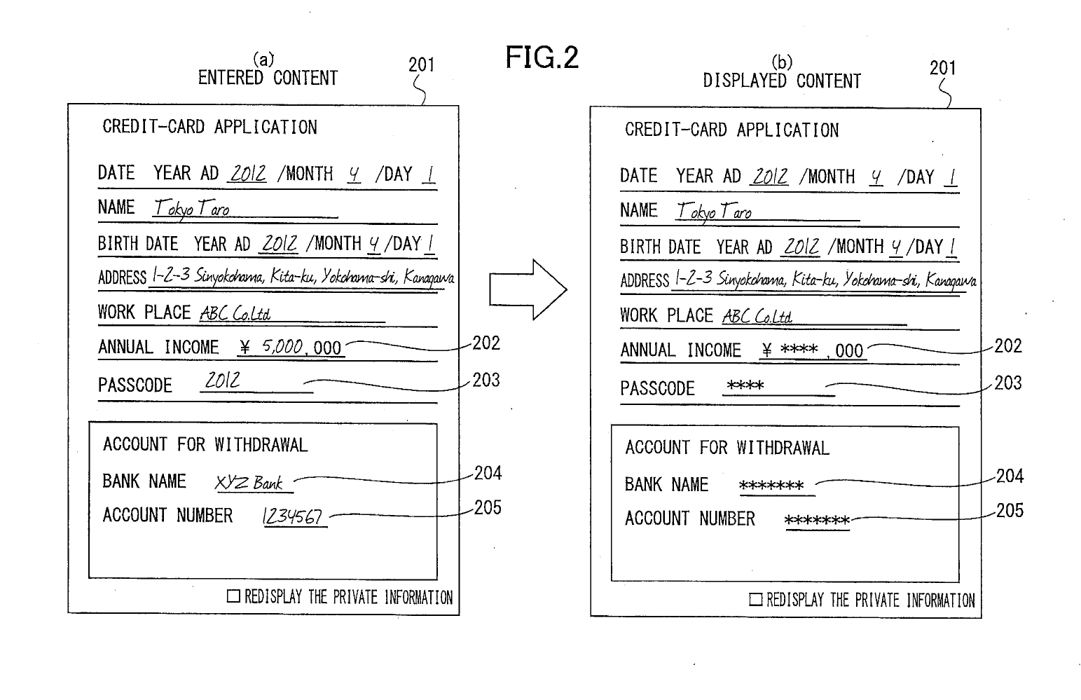

In FIG. 2 (a), a credit card application form is displayed on an input field 201 as an example of the document image of the designated form. In this example, the designated form includes entry fields indicating their item names including “DATE”, “NAME”, or “BIRTH DATE”. Moreover, such terms as “AD”, “YEAR”, “MONTH”, or “DAY” are displayed in advance to make an entry task easier. Furthermore, one or more entry fields (hereinafter referred to as “particular fields”) to input confidential information of items including “ANNUAL INCOME 202”, “PASSCODE 203”, “BANK NAME 204”, and “ACCOUNT NUMBER 205” are provided for each form in advance. And, each form further includes one or more additional functions such as to display a predetermined message or a checkbox in advance.

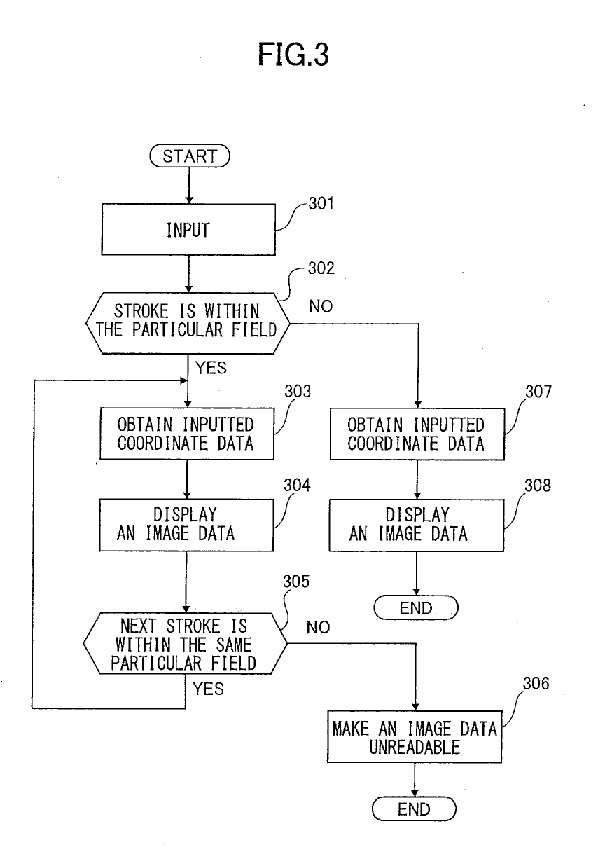

FIG. 3 illustrates a flowchart of an input processing in the information terminal device according to the present invention. At first, the document image of the designated form read out from the form storage section 103 is displayed. Next, when the information is inputted to the input section 101 in handwriting by a user (“step 301”), the input position sensing section 102 senses the coordinate of the handwritten information inputted, and a sensed coordinate is stored in the input coordinate data storage section 105 while entered in the judgment section 104.

Coordinate information of one or more particular fields included in the document images of the designated form is set in the judgment section 104 in advance. And the judgment section 104 judges whether or not an inputted positional coordinate of the handwritten information (“stroke”) is within the particular field of the form by comparing the inputted positional coordinate of the handwritten information with the inputted positional coordinate of the particular field (“step 302”).

Strokes configuring each of numeric characters of “2012_{—}4_{—}1” in the field “DATE” inputted in handwriting at the beginning are not within the particular field (“No” at step 302), that is to say they are not confidential information. Therefore, the image converting section 106 obtains the positional coordinate data of “2012_{—}4_{—}1” inputted in handwriting from the inputted coordinate data storage section 105 (“step 307”), converts a trajectory of the inputted coordinate data into a 2D (two-dimensional) image data, displays the image data on the display 110 as shown in FIG. 2 (b) (“step 308”), and stores the image data in the image data storage section 107.

Next, “NAME (Tokyo Taro)” is inputted and each stroke configuring its character is judged as to whether or not in a particular field. Since they are not within the particular field, “NAME (Tokyo Taro)” is displayed on the display 110 after being converted into an image data as shown in FIG. 2 (b). Further, “BIRTH DATE”, “ADDRESS”, “WORK PLACE” are displayed on the display 110 in the same manner as above.

Next, “ANNUAL INCOME” is inputted. Since “ANNUAL INCOME” is within the particular field (“Yes” at step 302), that is to say this is confidential information, the image converting section 106 obtains the data of the inputted positional coordinate (“step 303”) of the handwritten “ANNUAL INCOME”, converts a trajectory of the data of the inputted positional coordinate into the 2D image, displays it on the display 110 (“step 304”), and further, stores it in the image data storage section 107. Since the entry field of “ANNUAL INCOME” is within the particular field (“Yes” at step 302), the image converting section 106 obtains the inputted coordinate data of the strokes configuring “ANNUAL INCOME” inputted in handwriting (“step 303”), converts the trajectory of the inputted coordinate data into the 2D image data, displays the image data on the display 110 (“step 304”), and, stores the image data in the image data storage section 107.

If the next stroke is within the same particular field 202 (“Yes” at step 305), the image converting section 106 converts the trajectory of the inputted coordinate data into the 2D image data and displays the image data on the display 110 in the same manner as above.

If the next stroke is not in the same particular field 202 (“No” at step 305), that is to say, when a user finishes inputting the confidential information in the particular field 202 and moves into the next field, the image (“500”) displayed in the particular field 202 of the display 110 is made unreadable (“step 306”).

To make the confidential information unreadable, for example, the image data is displayed after converting into “asterisk (*)” as shown in FIG. 2 (b) or simply masked or blurred. Alternatively, a message saying, “Private information is hidden” may be displayed.

Furthermore, as shown in FIG. 2 (b), in the case the user needs to check the inputted data, a checkbox saying “Redisplay the private information” and redisplaying the private information when the user touches thereto can be displayed after the private information is hidden.

Next, “PASSCODE” is entered. Since “PASSCODE” is the confidential information within the particular field 203, PASSCODE is displayed after converting into “asterisk (*)” as is the case in ANNUAL INCOME. In the same way, “BANK NAME” in the particular field 204 and “ACCOUNT NUMBER” in the particular field 205 are inputted. When the “ACCOUNT NUMBER” in the particular field 205 as the last item of the particular fields is inputted, there are no more particular fields to be inputted. Therefore, a stroke outside of the particular field cannot be sensed. Instead, the judgment section 104 makes the image data displayed in the particular field 205 unreadable when a predetermined time frame has elapsed since the last stroke in the particular field (“step 306”).

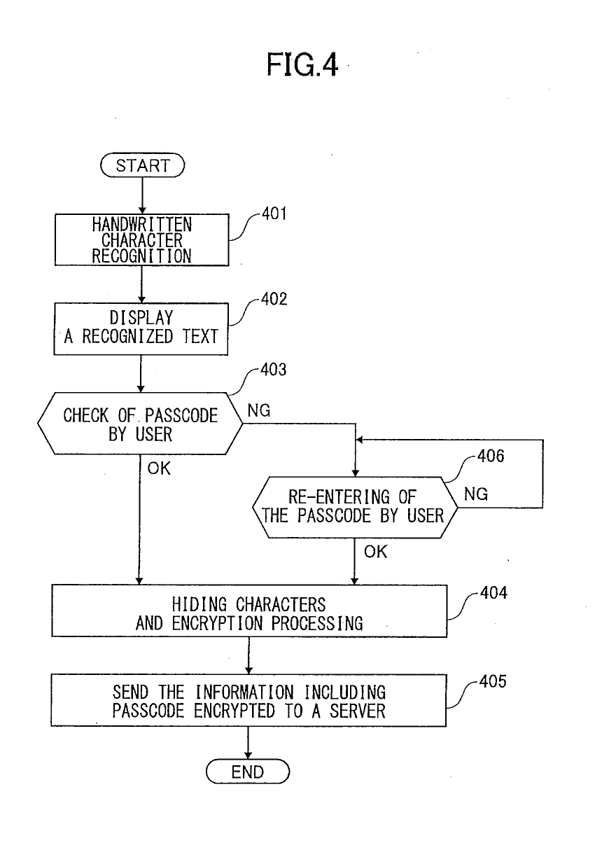

FIG. 4 illustrates the flowchart of confidential information processing in the information terminal device according to the present invention. The character recognition section 108 recognizes the image data inputted in handwriting within the particular field which is stored in the image data storage section 107 (“step 401”). The character recognition section 108 has a referential text library. After receiving an image data, the character recognition section 108 converts the image data into the text data by reference to the most similar text extracted from the text library, and stores the text data in the text data storage section 109.

Next, the recognized text data (e.g. passcode) is displayed in the display 110 (“step 402”) and checked by the user who inputted the data (“step 403”). If both of them are mismatched, the user re-enters, for example, the passcode in the particular field 203 (“step 406”). When it is confirmed that the recognized text data coincides with the passcode at step 403 and step 406, the text data displayed is made unreadable, and the encryption processing section 112 encrypts the text data by use of the encryption key at the same time (“step 404”). Then, the communicating section 111 sends the text data which is encrypted and the image data of a processing document which is stored in the image data storage section 107 to a server (“step 405”). In the present invention, it is intended that the information terminal device send information to the server ultimately. Therefore, each of the information terminal devices used in the same organization or for the same purpose stores a common public-key to encryption. On the other hand, the server receiving the encrypted information decrypts the encrypted information by use of the private-key.

In this way, confidential information can be prevented from being divulged by a simple method according to the first embodiment of the present invention. And, risk of a false recognition of the handwritten information can be reduced since the handwritten information is recognized within the information terminal device. That is to say, a user can confirm whether the handwritten information is correctly recognized or not, and correct it if necessary on the spot. Furthermore, information can be prevented from being divulged through a third party who has a higher level of access authority over information in the server since the handwritten information is encrypted within the information terminal device.

### (Second Embodiment)

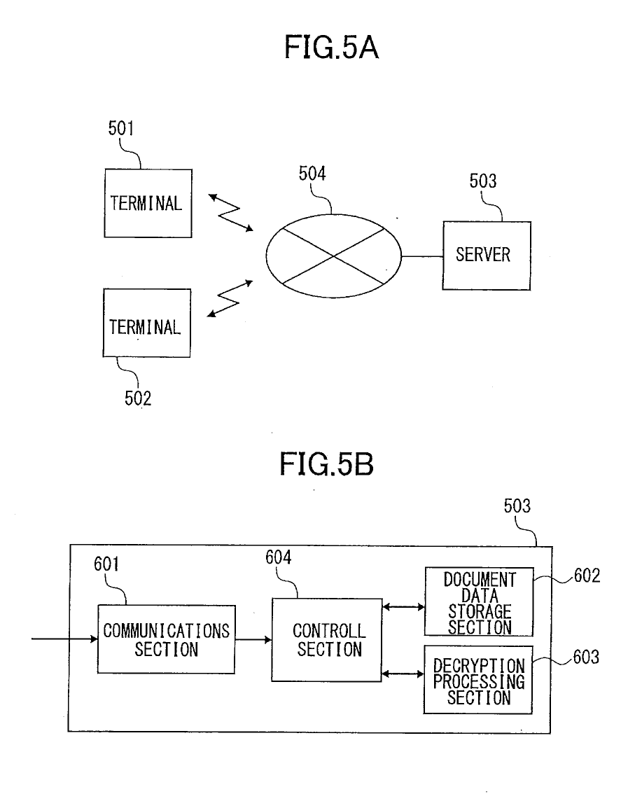

FIG. 5 A illustrates the configuration of the document management system according to the second embodiment of the present invention. The document management system according to the present invention has a configuration such that one or more information terminal devices are connected to one or more servers 503 through a network 504.

FIG. 5 B illustrates the configuration of the server 503. The server 503 includes a communicating section 601 receiving information from one or more information terminal devices (501, 502), a document data storage section 602 storing the image data and the encrypted text data, a decryption processing section 603 decrypting the encrypted information by use of the private-key, and a control section 604 controlling the entire server.

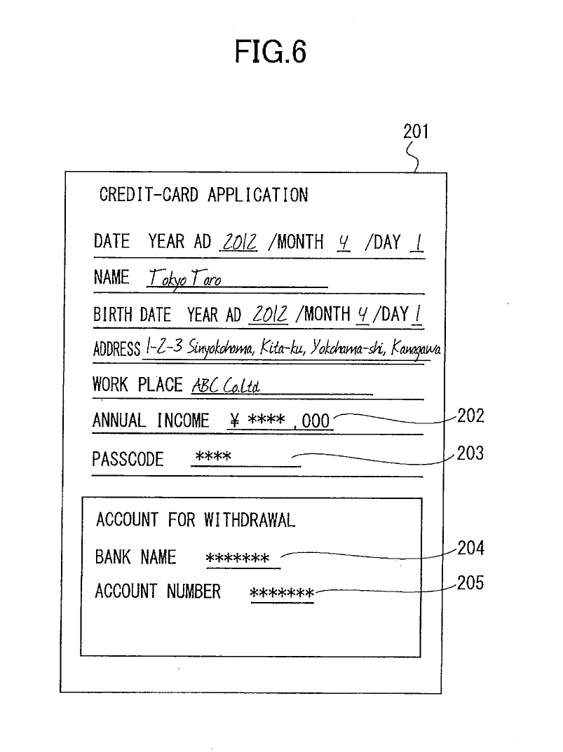

The image data sent from the information terminal devices and the encrypted text data are stored in the document data storage section 602 for each document. Only a user who has access authority can decrypt the confidential information such as a passcode by use of the private-key, since such confidential information converted into the text data is encrypted. If a user who does not have access authority for the confidential information opens the document, the confidential information fields 202 to 205 are, for example, converted into asterisk (*) and unreadable as shown in FIG. 6. Note that, one or more policies for access control such as user authentication may be set for each document in order to prevent confidential information from being divulged aside from accessing the server.

Thus, in the second embodiment of the present invention, confidential information can be prevented from being divulged through the server since the confidential information is on closed access, and the confidential information is encrypted before sending to the server.

Although the present invention has been described in terms of exemplary embodiments, it is not limited thereto. It should be appreciated that variations may be made in the embodiments described by persons skilled in the art without departing from the scope of the present invention as defined by the following claims.

What is claimed is:

1. An information terminal device, comprising:
an input section to input information in handwriting on an entry screen displaying a designated form of a document;
a judgment section judging whether or not a positional coordinate inputted in handwriting is within a particular field of the designated form; and
a control section controlling the entire information terminal device to display the information inputted in handwriting within the particular field on the particular field while the coordinate of the information inputted in handwriting remains within the particular field, and to make the information inputted in handwriting displayed in the particular field unreadable when the coordinate of the information inputted in handwriting is outside of the particular field or when a predetermined time frame has elapsed since the last stroke in the particular field.

2. The information terminal device according to claim 1, comprising a character recognition section recognizing the information inputted in handwriting within the particular field and converting the information into a text data wherein the control section displays the text data recognized in the particular field.

3. The information terminal device according to claim 1, wherein the control section allows the information terminal device to be inputted with the information in handwriting again when the text data recognized does not coincide with the information inputted in handwriting.

4. The information terminal device according to claim 2, comprising an encryption processing section encrypting the text data recognized.

5. The information terminal device according to claim 1, wherein the particular field is a field in which designated confidential information is inputted in handwriting.

6. The information terminal device according to claim 1, wherein the particular field is the field set for each document having the designated form in advance.

7. A method of protecting handwritten information in an information terminal device to input information in handwriting on an entry screen which displays a designated form of a document, the method comprising:
controlling to display the information inputted in handwriting within a particular field in the particular field, and to make the information inputted in handwriting displayed in the particular field unreadable when the coordinate of the information inputted in handwriting is outside of the particular field or when a predetermined time frame has elapsed since the last stroke in the particular field.

8. The method of protecting handwritten information according to claim 7, wherein the information inputted in handwriting within the particular field is displayed after converting into a text data.

9. The method of protecting handwritten information according to claim 8, wherein the information inputted in handwriting and converted into the text data is encrypted.

10. The method of protecting handwritten information according to claim 7, wherein the information inputted in handwriting within the particular field is designated confidential information.

11. A document management system, comprising one or more information terminal devices and one or more processing devices, wherein an information terminal device comprises:
an input section to input information in handwriting on an entry screen which displays a designated form of a document;
a judgment section judging whether or not an inputted positional coordinate is in a particular field of the designated form;
a control section controlling the entire information terminal device to display the information inputted in handwriting within the particular field in the particular field while the coordinate of the information inputted in handwriting is within the particular field, and to make the information inputted in handwriting displayed in the particular field unreadable when the coordinate of the information inputted in handwriting is outside of the particular field or when a predetermined time frame has elapsed since the last stroke in the particular field;
an image converting section converting the inputted positional coordinate data into an image data;
a character recognition section recognizing the information inputted in handwriting within the particular field and converting the information into a text data, wherein the control section displays the text data recognized in the particular field;
an encryption processing section encrypting the text data recognized;
a communicating section sending the text data and the image data which are encrypted to a server;
a communicating section receiving the text data and the image data which are encrypted sent from the information terminal device;
a document data storage section storing the encrypted text data and the image data in each document, and
a decryption processing section decrypting the encrypted text data by use of the private-key.

12. The document management system according to claim 11, wherein the text data is designated confidential information, the encryption processing section encrypts the information by use of a public-key, and the decryption processing section decrypts the encrypted information by use of a private-key.
